(19) United States
(12) Patent Application Publication
(10) Pub. No.: US 2002/0154782 A1
(43) Pub. Date: Oct. 24, 2002

(54) System and method for key distribution to maintain secure communication

(76) Inventors: Richard T. Chow, Santa Clara, CA (US); Desmond C. Chan, Mountain View, CA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/104,049

(22) Filed: Mar. 25, 2002

Related U.S. Application Data
(60) Provisional application No. 60/278,312, filed on Mar. 23, 2001.

(51) Int. Cl. H04L 9/00

(52) U.S. Cl. 380/278

(57) ABSTRACT

A system and method distributes keys from a central node to branch nodes in a tree network. The central node and the branch nodes within the tree network are initialized. A root public/private key pair is generated by the central node. Each branch node is loaded with the root public key and a unique branch public/private key pair. A generated group key is distributed to the associated branch nodes. New branch nodes are given the group key after they are associated with the network. Re-keying of the group key throughout the system is done via the central node either at the expiration of the group key, when a node is not sure if a group key is still valid, or when the group key has been compromised.

### CROSS-REFERENCE TO RELATED APPLICATIONS

This application claims priority to U.S. Prov. Appl. No. 60/278,312, filed Mar. 23, 2001.

### BACKGROUND OF THE INVENTION

1. Field of the Invention

The invention described herein relates generally to computer networks and, more particularly, to a system and method for key distribution to maintain secure communications between distributed network nodes.

2. Background Art

Secure communication between nodes (or stations) is gaining importance in today's networks. Confidentiality (privacy of messages) and authentication (detection of message modification) are often requirements. Cryptography, including public/private key techniques and symmetric keys (ciphers), provide various ways to meet these requirements based on secret keys.

A scalable content delivery network (SCDN) is a group of communicating network nodes that cooperate to deliver data files quickly and transparently to data users. An example SCDN is taught in U.S. patent application Ser. No. 09/984,019 filed May 15, 2001, whose teachings are incorporated herein by reference. The communication networks use the File Distribution Protocol (FDP) Protocol, an application layer protocol designed for use within an SCDN. An example FDP is taught in U.S. patent application Ser. No. 09/681,644, filed May 15, 2001 and U.S. patent application Ser. No. 09/984,024, filed Oct. 26, 2001, whose teachings are incorporated herein by reference. FDP traffic, as well as other SCDN communication, often requires confidentiality and authentication.

Typically, communicating nodes generate a symmetric key for communication with each other, similar to SSL (Secure Sockets Layer). The advantage of this approach is de-centralization because only the two communicating parties are involved in the symmetric key generation. Unfortunately, problems with this approach include: (1) each node will have to manage the symmetric keys for all parties with whom it communicates, and (2) there is a startup time for generating the symmetric key when two parties begin to communicate. Therefore, such an approach would also be problematic in an SCDN because latency to media users is critical. Secure channels could be setup ahead of time, but then channel management would be cumbersome given the dynamic nature of SCDNs.

The requirements for key management within an SCDN include: (1) initialization of keys before communication starts and (2) scalable re-keying. The key can be common throughout the SCDN as traffic between two SCDN nodes need not be protected from a third node. This “group key” management problem has been studied, e.g., see Ballardie, Internet Engineering Task Force (IETF) RFC 1949, “Scalable Multicast Key Distribution,” May 1996 and B. D. Wallner et al., IETF RFC 2627, “Key Management for Multicast: Issues and Architectures,” June 1999, but in the context of IP multicast.

There remains a need for a system and method to perform key management and distribution so that SCDN nodes agree on a common, global key.

### BRIEF SUMMARY OF THE INVENTION

One embodiment of the invention provides a method of distributing keys from a central node to branch nodes in a tree network. The method comprises the steps of initializing the tree network, loading a unique branch public/private key pair onto each of the branch nodes, and associating the nodes within the tree network. The method further comprises the steps of generating, at the central node, a root public/private key pair and loading the root public key onto the branch nodes. The method further comprises the steps of synchronizing clocks in the branch nodes with a clock in the central node, generating a group key, indicating a start and expiration time for the group key, and distributing the group key to the branch nodes.

Another embodiment provides a similar method for distributing keys in a tree network. The difference between this embodiment and the previous is that in this embodiment the method in addition comprises the step of signing the group key and the start and expiration times in the central node. This method in addition comprises the step of verifying this signature at the receiving node.

Another embodiment provides a system for distributing keys in a tree network. The system comprises a central node and branch nodes coupled to the central node. The system further comprises a branch node key controller that loads unique branch public/private key pairs onto each of the branch nodes. The central node comprises a key controller that generates a root public/private key pair as the keys and a controller that controls the distribution of the root public key to the branch nodes.

An advantage of the method and system of the invention is that there is an ability for scalable, on-demand group key agreement within an SCDN.

### BRIEF DESCRIPTION OF THE DRAWINGS/FIGURES

In the drawings, like reference numbers indicate the same or substantially the same elements. Furthermore, the left-most digit(s) of the reference numbers indicate the number of the drawing in which the reference number is first used. The accompanying drawings, which are incorporated in and constitute a part of the specification, illustrate an embodiment(s) of the invention and, together with the description, explain the purpose, advantages, and principles of the invention.

FIG. 1 depicts a system according to an embodiment of the invention.

FIG. 2 depicts elements in a central node of the system in FIG. 1.

FIG. 3 depicts elements in branch nodes of the system in FIGS. 1 and 2;

FIG. 4 is a flowchart depicting the steps for initializing the system according to an embodiment of the invention.

FIG. 5 is a flowchart depicting the steps for generating and distributing keys from a central node to branch nodes according to an embodiment of the invention.

FIG. 6 is a flowchart depicting the steps to synchronize all node clocks and distribute keys from a central node to branch nodes according to an embodiment of the invention.

FIG. 7 is a flowchart depicting the steps to synchronize all node clocks and distribute keys from a central node to branch nodes according to an embodiment of the invention.

FIG. 8 is a flowchart depicting the steps to re-key branch nodes according to an embodiment of the invention.

FIG. 9 is a flowchart depicting steps to monitor for a compromised group key according to an embodiment of the invention.

### DETAILED DESCRIPTION OF THE INVENTION

The invention is described with reference to specific architectures and protocols. Those skilled in the art will recognize that the description is for illustration and to provide the best mode of practicing the invention. An embodiment of the invention provides an improved mechanism for group key distribution throughout a computer network. In the following description, numerous details are set forth to provide a more thorough description of embodiments of the invention. The description is not meant to be limiting.

Key distribution is the mechanism employed to ensure that cryptographic keys are distributed to stations or nodes, where station or node is used interchangeably throughout the instant application, for use in securing station-to-station or node-to-node communication. This mechanism is used to solve the key management problem, which is commonly perceived as the biggest challenge in securing a distributed network.

I. Key Distribution System and Method

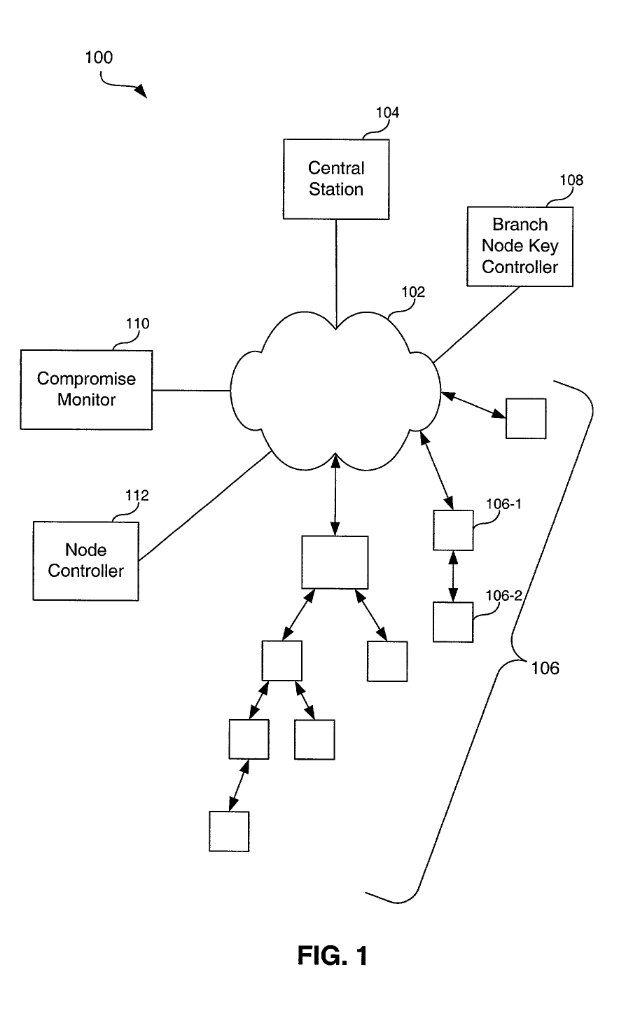

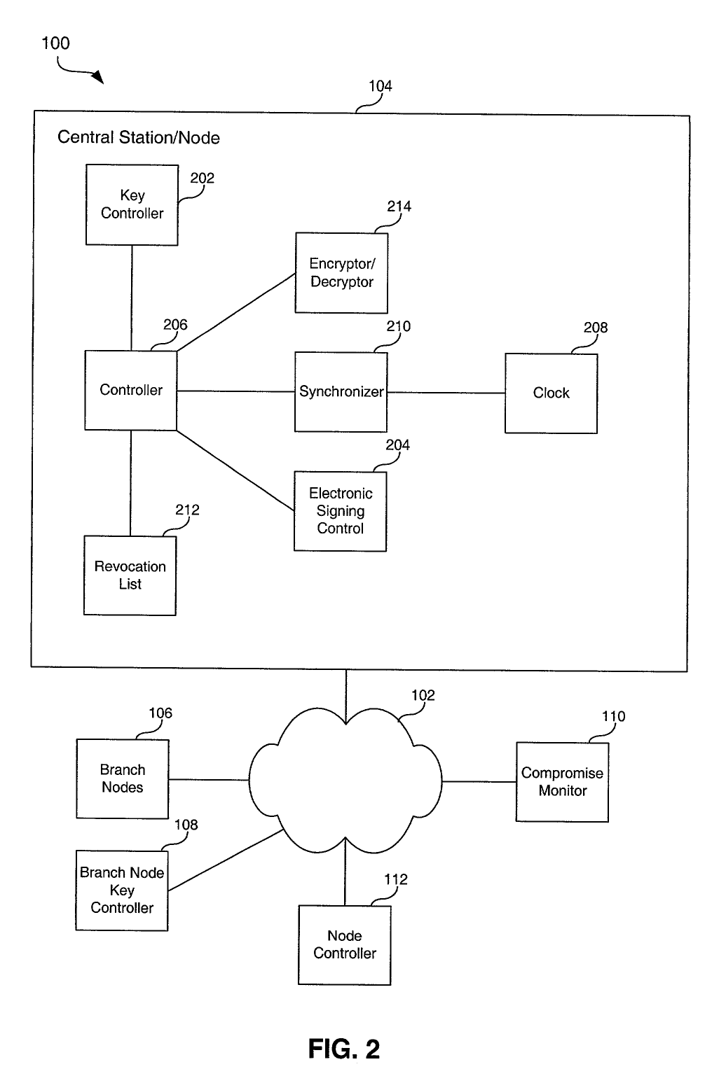

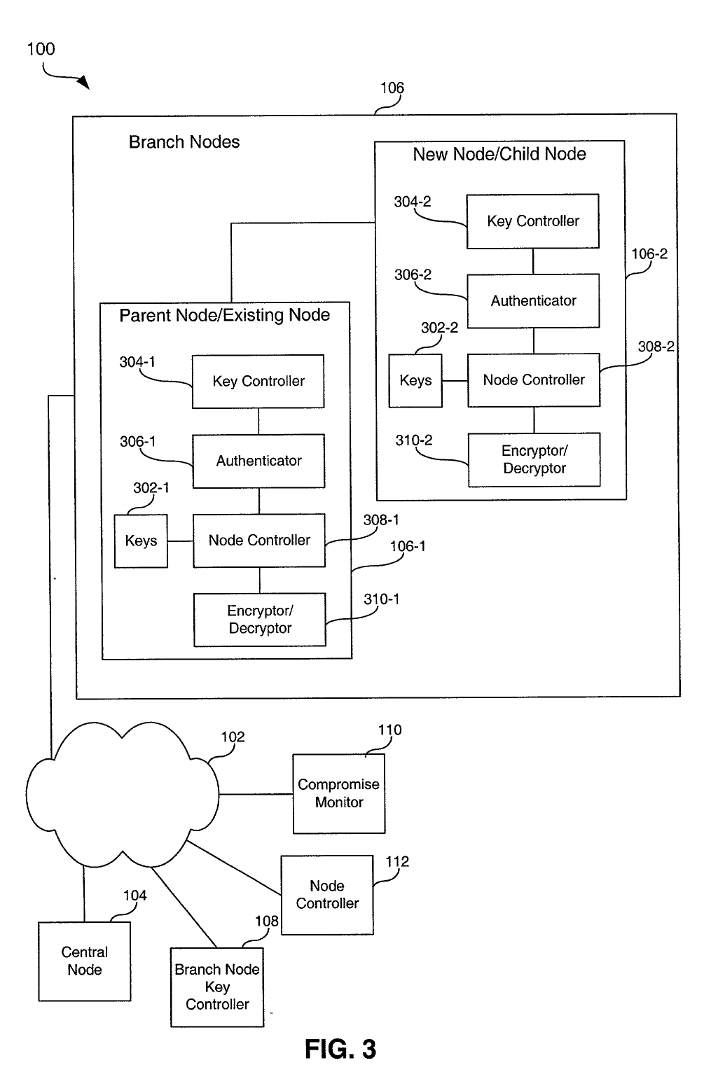

A key distribution system 100 is shown in FIG. 1, where details of certain elements in the system 100 are shown in FIGS. 2-3. The system 100 may be a portion of an SCDN. The system 100 comprises a network core or backbone 102 coupled to a central station or node 104, branch stations or nodes 106, a branch node key controller 108, a compromise monitor 110, and a node controller 112. Each of these elements can be implemented in software, hardware, or a hybrid system, as is known in the art. In one embodiment, the system 100 is a tree network comprising the central node 104 and the branch nodes 106. The arrangement of nodes 106 may be in any conceivable order with various parent/child relationships between the nodes, as is known in the art. In the hierarchy, a parent node is one step closer to the central node 104 than the child node. As one example, node 106-1 is a parent node of node 106-2, while the central node 104 is a parent node of node 106-1. Thus, node 106-1 is both a parent and child node.

Turning now to FIG. 2, details of the central node 104 are shown. The central node comprises a key controller 202 and an electronic signing control 204, which are both coupled to a controller 206. Also, a clock 208 is coupled to a synchronizer 210 such that, via the controller 206, the synchronizer synchronizes all the clocks in the system 100. The central node 104 further comprises a revocation list memory 212 and an encryptor/decryptor 214, which are both coupled to and controlled by the controller 206. The function of the central node 104 and its elements is described in more detail below. Also, as discussed above, the elements within the central node 104 may be implemented in software, hardware, or a hybrid system.

With reference to FIG. 3, details of the branch nodes 106 are shown. In this figure, for convenience, only two branch nodes 106-1 and 106-2 are shown, where 106-1 is a parent node of 106-2. The branch nodes each comprise a key storage 302 partially controlled by a key controller 304 and partially controlled by a controller 308. The controller also controls an authenticator 306 and an encryptor/decryptor 310. The function of the branch nodes 106 and their elements are described in more detail below. Also, as discussed above, the elements within the branch nodes 106 may be implemented in software, hardware, or a hybrid system.

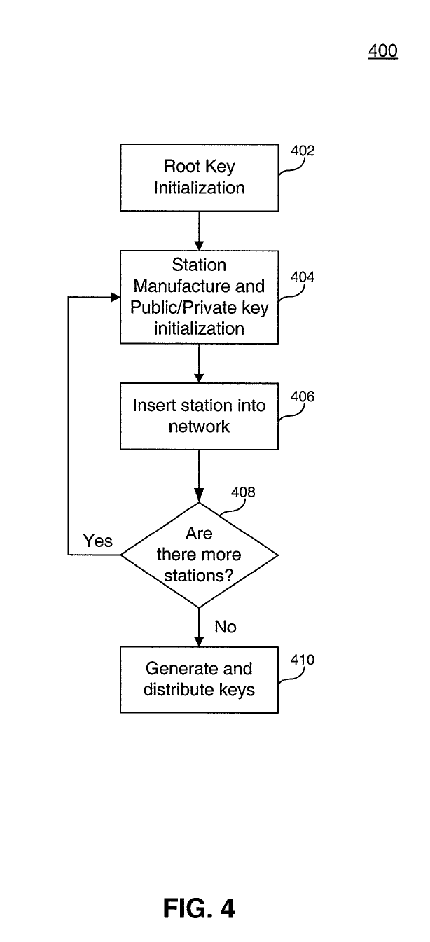

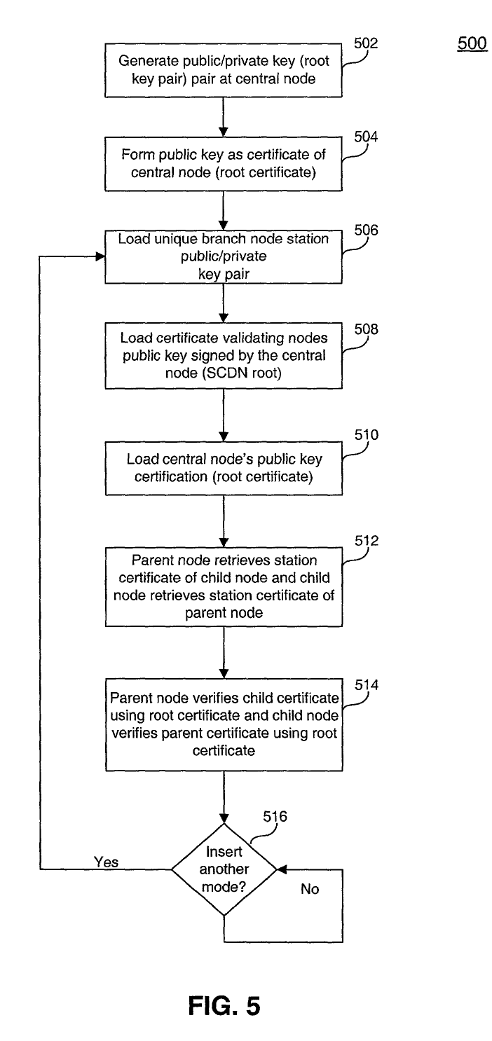

An overall method 400 of key distribution in system 100 is shown in FIG. 4, where sub-operations are shown in FIGS. 5-9 and discussed in detail below. A root key pair, i.e. a root public key and a root private key, is generated at step 402. A branch node is manufactured and the node's unique branch public/private key pair is generated at step 404. The manufactured branch node 106 is inserted into the network 102 at step 406. A determination is made whether other branch nodes 106 need to be associated and inserted into the system 100 at step 408. if yes, steps 404-408 are repeated. If no, the method 400 generates the group key, which is distributed by the branch node key controller 108 at step 410.

II. Communicating in the Network

Depending on the operational environment of the system 100, each message coming from another branch node 106 that is intended for the branch nodes 106 may be “signed” in order to guarantee its authenticity. Both the sender and receiver must share a secret, symmetric key to do the signing and verifying. The form of the signature will be as a message authentication code (MAC) attached to each message. An example of such a MAC is the HMAC algorithm, e.g., see Krawczyk et al., (IETF) RFC 2104 “HMAC: Keyed-Hashing for Message Authentication,” February 1997. The SCDN uses symmetric keys to do the signing rather than asymmetric key pairs because the speed of signing with symmetric keys is orders of magnitude faster. An entire message need not be signed because the MAC can authenticate only part of the message if desired.

Also, depending on the operational environment of the system 100, each message intended for a branch node 106 may be encrypted to guarantee its confidentiality. This message comes from another branch node 106. Both the sender and receiver must also share a secret, symmetric key to do the encryption and decryption. For example, the encryption could be done with an algorithm such as Rijndael, e.g., see http://csrc.nist.gov/encryption/aes/rijndael/ Rijndael.pdf. Accordingly, in normal operation a branch node 106 would need two secret keys, which would be used for encryption and authentication and shared among all nodes 104 and 106.

III. File Distribution Protocol

The File Distribution Protocol (FDP) defines the file management primitives necessary to transfer, store, and manipulate content provider files, file metadata, and keys stored in a network, where the system 100 is within the network. Such primitives include commands that upload, distribute, deliver, modify, and delete files and keys. The FDP commands result in one or more packets or keys being transferred between appropriate servers in the network. It will be evident to those skilled in the art that the specific command names and protocol implementation described herein are by way of example and that other commands or protocols may be added, subtracted, or substituted so long as they result in efficient and reliable transfer of files and keys within the network. As discussed above, U.S. patent application Ser. Nos. 09/681,644 and 09/984,024 both teach a system using FDP.

IV. Public/Private Key Initialization and Public Key Distribution

The main key-agreement operation of the invention relies on a simple public/private key infrastructure, as is known to persons of ordinary skill in the art. This infrastructure consists of a root public/private key pair, a branch public/private key pair for each station, and a Certificate Revocation List (CRL), which is a list of revoked keys.

As seen in FIG. 5, a portion of the overall method of FIG. 4 that associates and manufactures the branch nodes 106 and distributes the root public key from the central node 104 is shown. A root public/private key pair is generated by the central node 104 at step 502. This is performed by the key controller 202 in FIG. 2. The root public key is formed as a certificate by the key controller 202 at step 504. The root certificate could be self-signed by the electronic signing control 204 in FIG. 2 or signed by a recognized third party, such as VERISIGN. A unique public/private key pair is then generated and loaded onto each associated branch node 106 by the branch node key controller 108 at step 506. A certificate validating each branch node's public key is signed by the SCDN root and then loaded at the branch nodes 106 at step 508. The root public key is then loaded by a central node controller 206 (FIG. 2) at step 510.

When a new branch node 106 has been inserted into the system 100, the new branch node 106 learns the public keys of its parent node and the parent learns the new branch node's public key. The mechanism for this learning may be similar to learning the IP addresses of its parent node and can be performed by the SCDN configuration subsystem. The association of new branch nodes 106 initiates retrieval of a station certificate of the parent node at the child node and retrieval of a station certificate of the child node at the parent node. As an example, as seen in FIG. 3, if node 106-2 were the new node, then node 106-1 would be its parent node and the keys in storage 302-1 would be retrieved by key controller 304-2 and the key controller 304-1 would retrieve the keys in storage 302-2 at step 512. At step 514, the retrieved keys are authenticated by authenticators 306-1 and 306-2 using the root public key and, if authenticated, a node controller 308-2 controls the acceptance of data from other branch nodes 106. The method 500 determines whether other new branch nodes 106 have been associated with the system at step 516 using the node controller 112. If yes, steps 506 through 514 are repeated. If no, the method 500 continues to check for new branch nodes 106 using the node controller 112.

V. Distribution and Re-Keying of Group Key to Branch Nodes

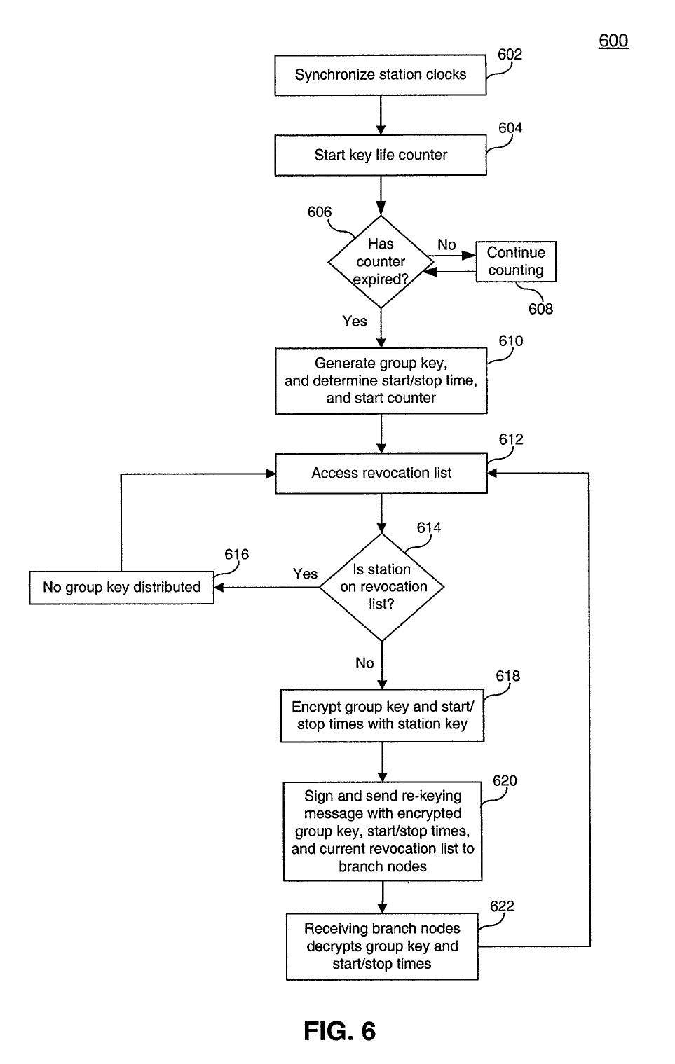

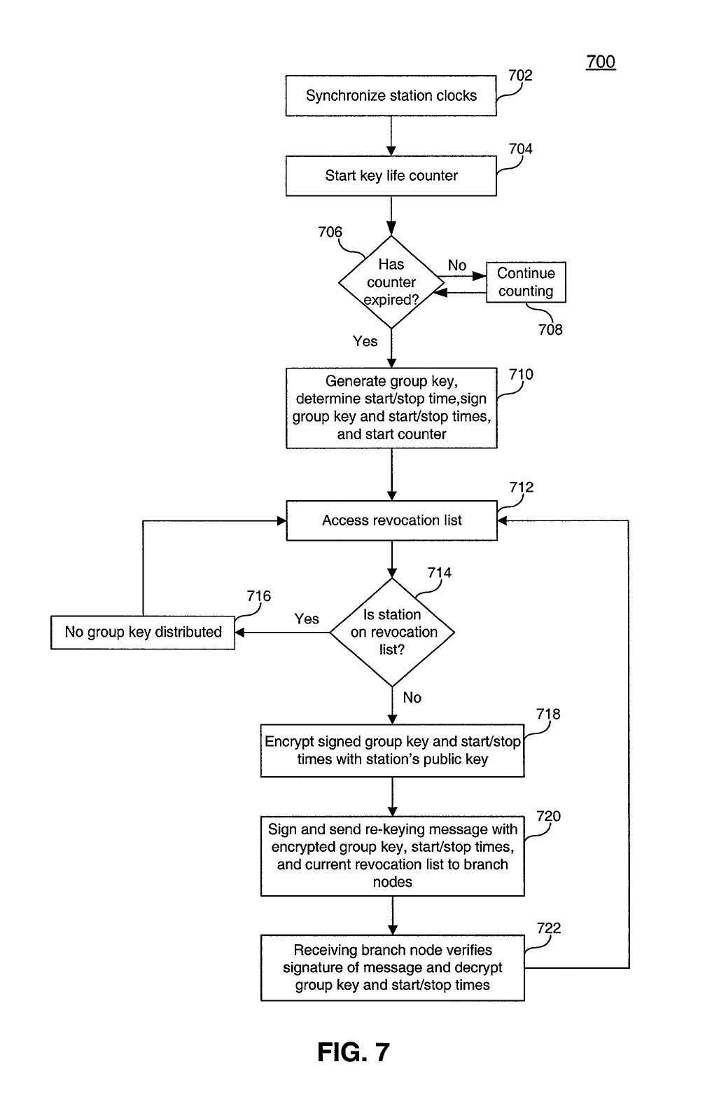

In this section several embodiments are described for methods to use the public/private key infrastructure to distribute the group key. The group key represents any confidential piece of information shared among all the nodes 104 and 106, but will often be a set of symmetric keys for purposes of signing and encrypting, as described above. The group key has an associated time period having a start time and an expiration time. Each of the nodes 104 and 106 must have a synchronized clock in order for the time periods to function. The start time may have a value of IMMEDIATE if, for example, an old group key has been compromised and all the nodes 104 and 106 must switch over to a new group key. In normal operation, the start time may be well after all the nodes 106 have received a re-keying message with a group key from the central node 104. For example, if the entire tree traversal takes 15 minutes, the re-keying message can be sent 30 minutes before a start time. For convenience, the methods below will assume that the group key contains the start and expiration times of the keys, as well as, the keys themselves. In some embodiments, the messages passed from the central node 104 to the branch nodes 106 to accomplish re-keying are part of a FDP protocol discussed above, which may be implemented by a distribution server (DS) subsystem. Two embodiments of methods utilized for re-keying of branch nodes 106 are shown in FIGS. 6-7.

Turning now to FIG. 6, a method 600 for re-keying branch nodes 106 is shown. The central node clock 208 synchronizes all branch node clocks in the node controller 308 using the synchronizer 210 at step 602. The controller 206 sets a start and expiration time for a group key, generated by the key controller 202, and starts a counter inside the controller 206 at step 604. Whether the counter has expired is determined at step 606. If no, the counter is continued at step 608. If yes, a new group key is generated by the key controller 202, a start/expiration time is set, and the counter is reset at step 610. A revocation list is accessed from the storage 212 at step 612. A determination is made whether each individual branch node 106 has a key that is on the revocation list at step 614. If yes, no group key is distributed to the corresponding branch node 106 at step 616 and the method 600 returns to step 612.

If the method 600 determines no at step 614, at step 618 the group key and start/stop times are encrypted by the encryptor/decryptor 214 with the public key of the non-revocation list branch node 106. Also at step 618, the controller 206 forms a message consisting of the encrypted group key, start/stop times, and the current revocation list. Further at step 618, the electronic signing control 204 signs this message with the public key of the non-revocation list branch node 106. The signed message is then sent to the non-revocation list branch node 106 using the FDP protocol at step 620. The non-revocation list branch node 106 authenticates the signature of the sending node with authenticator 306, and if authenticated, the non-revocation list branch node 106 decrypts the group key and start/stop times with the encryptor/decryptor 310 under control of the node controller 308 at step 622. The method 600 then returns to step 612 for repetition of the method for each child node. Each child in turn goes to step 612 for each of its children.

An alternative method 700 for distributing the group key to the branch nodes 106 is shown in FIG. 7. As in method 600, a group key is created by the key controller 202 when a key life counter expires. The group key and its start/stop times are signed by the electronic signing control 204 at step 710. The other steps are similar to method 600, except the group key recipient verifies the signature on the group key. A revocation list is accessed from the storage 212 at step 712. A determination is made whether each individual branch node 106 has a key that is on the revocation list at step 714. If yes, no group key is distributed at step 716 and the method 700 returns to step 712.

If the method 700 determines no at step 714, at step 718 the group key is encrypted by the encryptor/decryptor 214 with the public key of the non-revocation list branch node 106. The controller 206 electronically signs and sends the encrypted signed group key, start/stop times, and the current revocation list to the non-revocation list branch node 106 using the FDP protocol at step 720. At step 722 the non-revocation list branch node 106 authenticates the signature of the sending branch node 106 that is on the message with authenticator 306 and, if the message is authentic, the non-revocation list branch node 106 decrypts the group key with the encryptor/decryptor 310 under control of the node controller 308. Also at step 722, the non-revocation list branch node 106 authenticates the signature on the group key and start/stop times of the central node with authenticator 306. The method 700 then returns to step 712 for repetition of the method 700 for each child branch node 106. Each child branch node 106 in turn goes to step 712 for each of its children branch nodes 106.

VI. On-Demand Re-Keying of Group-Key to Branch Nodes

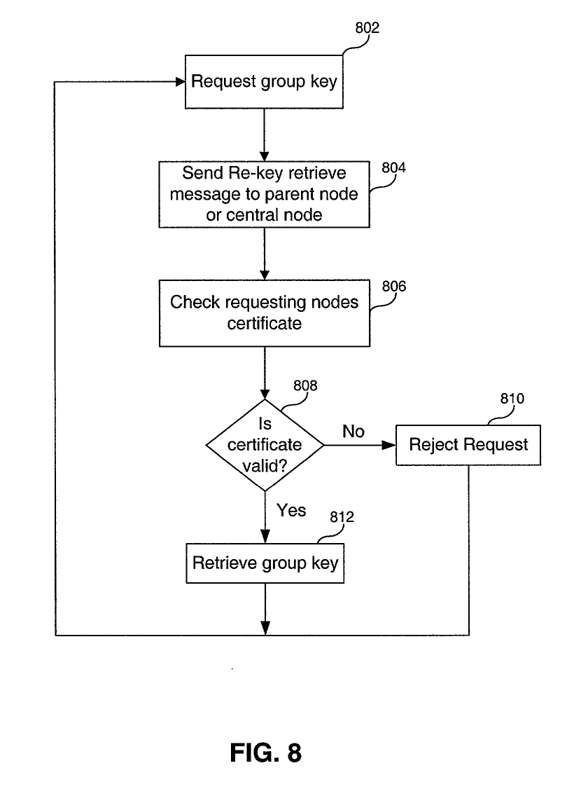

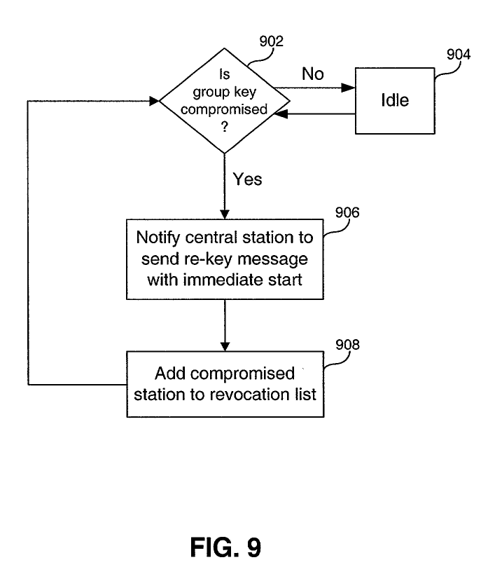

There are several instances where a group key is distributed outside of a normal periodic re-keying cycle. One instance may be when a branch node 106 goes down and comes back up and the group key may have expired. Another instance may be when a branch node's group key may be nearing expiration and no re-keying message has been received. To re-key for these instances a method 800 is shown in FIG. 8. In another embodiment, as shown by method 900 in FIG. 9, a branch node 106 or the entire system 100 may become compromised, which means the group key becomes known by non-network nodes. When this occurs, an immediate re-keying needs to take place.

During operation of method 800, a requesting branch node 106 sends a request to a parent node that a group key is needed at step 802. The FDP protocol is used to retrieve the group key and a node certificate of the requesting branch node 106 is sent to the parent branch node 106 by the node controller 308 in the requesting node 106 at step 804. The group key request is authenticated by the authenticator 306 in the parent branch node at step 806. A determination is made by the node controller 308 whether the authentication was successful at step 808. If no, the request is rejected at step 810 and the method 800 returns to step 802. If yes, the key controller 304 of the parent branch node 106 sends the group key to the key controller 304 of the requesting branch node 106 at step 812 and the method 800 returns to step 802.

Referring to FIG. 9, during operation of method 900, the compromise monitor 110 continuously monitors to determine if the group key is compromised at step 902. If no, then the system 100 remains idle as indicated by step 904, while the method 900 continues to monitor for a compromised group key at step 902. If yes, the central node 104 is notified at step 906 that (1) that the group key needs to expire immediately, (2) a new group key needs to be generated immediately, and (3) the new group key needs to be immediately distributed to the branch nodes 106. At step 908 a compromised branch node 106 is added to the revocation list stored in storage 212 in the central node 104 that is accessed during operation of methods 600 and 700. The method 900 then returns to step 902 and continues to monitor for a compromised group key.

VII. Conclusion

Example embodiments of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalence.

What is claimed is:

1. A method of distributing keys from a central node to branch nodes in a tree network, the method comprising the steps of:
initializing said tree network;
loading a unique branch public/private key pair onto each of said branch nodes;
associating said nodes within said tree network;
generating, at said central node, a root public/private key pair; and
loading said root public key onto said branch nodes.

2. The method of claim 1, further comprising the step of converting said root public key to a root certificate.

3. The method of claim 1, wherein said associating step further comprises the steps of:
associating a new node with an existing node in said tree network;
loading said root public key to said new node;
retrieving a public key of said existing node at said new node;
authenticating said public key of said existing node using said root public key at said new node; and
accepting data at said new node only if said authenticating is successful.

4. The method of claim 1, further comprising the steps of:
synchronizing clocks in said branch nodes with a clock in said central node;
generating a group key;
indicating a start and expiration time for said group key; and
distributing said group key to said branch nodes.

5. The method of claim 4, further comprising the steps of:
accessing a revocation list before said distributing of said group key;
determining whether each said branch node is on said revocation list; and
performing said distributing of said group key based on said determination.

6. The method of claim 5, further comprising the steps of:
encrypting said group key with a public key of a non-revocation list branch node;
distributing said encrypted group key to said non-revocation list branch node; and
distributing said revocation list to said non-revocation list branch node.

7. The method of claim 1, further comprising the steps of:
generating a group key;
determining whether a requesting branch node needs said group key;
transmitting a group key request to a parent node of said requesting branch node;
authenticating said group key request at said parent node; and
distributing said group key to said requesting branch node from said parent node if said authenticating is successful.

8. The method of claim 1, further comprising the steps of:
generating a group key;
electronically signing said group key;
encrypting said signed group key with a public key of a child branch node;
transmitting said encrypted signed group key to said child branch node;
decrypting said encrypted signed group key at said child branch node;
authenticating said decrypted group key; and
using said group key at said child branch node if said authenticating is successful.

9. The method of claim 1, further comprising the steps of:
generating a group key;
monitoring if said group key has been compromised;
notifying said central node if said monitoring determines said group key has been compromised; and
updating a revocation list.

10. The method of claim 9, wherein said notifying step further comprises the steps of:
transmitting a signal to said central node to indicate immediate expiration of said group key and to immediately generate and distribute a new group key to all said branch nodes.

11. A system for distributing keys in a tree network comprising:
a central node;
branch nodes coupled to said central node; and
a branch node key controller that loads unique branch public/private key pairs onto each of said branch nodes;
said central node comprising
a key controller that generates a root public/private key pair as said keys, and
a controller that controls the distribution of said root public key to said branch nodes.

12. The system of claim 11, wherein said root public key is a certificate.

13. The system of claim 11, further comprising:
a node controller that associates new nodes with existing nodes in said tree network, said new node comprising:
a key controller that retrieves said root public key from said existing node and that retrieves a public key of said existing node at said new node;
an authenticator that authenticates said public key of said existing node using said root public key at said new node; and
a node controller that controls the acceptance of data at said new node based on if said authenticating is successful.

14. The system of claim I1, wherein said central node further comprises:
a synchronizer to synchronize clocks in said branch nodes with a clock in said central node,
wherein said key controller generates a group key with a start time and an expiration time, and
wherein said controller controls the distribution of said group key to said branch nodes.

15. The system of claim 14, wherein said controller accesses a revocation list and determines whether each branch node is on said revocation list before distributing said group key.

16. The system of claim 15, wherein said central node further comprises an encryptor for encrypting said group key with a public key of non-revocation list branch nodes and wherein said controller controls the distribution of said encrypted group key and said revocation list to said non-revocation list branch nodes.

17. The system of claim 11, wherein:
said key controller in said central node generates a group key;
said system further comprises a branch node key controller that determines whether a requesting branch node needs said group key, wherein if said group key is needed it is transmitted to a parent node of said requesting branch node; and
said parent node comprises
an authenticator that authenticates said group key, and
a key controller that controls distribution of said group key to said requesting branch node from said parent node, wherein said group key is only distributed if said group key request is authenticated.

18. The system of claim 11, wherein:
said key controller in said central processor generates a group key, wherein said central node further comprises
an electronic signature controller that controls the electronic signing of said group key, and
an encryptor that encrypts said signed group key with a public key of a child branch node,
wherein said controller in said central node controls the transmitting of said encrypted signed group key to said child branch node,
said child branch node comprising
a decryptor that decrypts said encrypted signed group keys, and
an authenticator that authenticates said decrypted group key, wherein said group key is used at said child branch node if it is determined to be authentic.

19. The system of claim 11, wherein:
said controller in said central node generates a group key;
said system further comprises a compromise monitor that monitors if said group key has been compromised and that notifies said central node if it is determined said group key has been compromised.

20. The system of claim 19, wherein when it is determined said group key has been compromised said compromise monitor:
transmits a signal to said central node to indicate that an immediate expiration of said group key is required;
transmits a signal to said central node to immediately generate and distribute a new group key to all said branch nodes; and
transmits a signal to said central node to update a revocation list stored in said central node.
